(19) United States
(12) Patent Application Publication
(10) Pub. No.: US 2021/0166698 A1
(43) Pub. Date: Jun. 3, 2021

(54) INFORMATION PROCESSING APPARATUS AND INFORMATION PROCESSING METHOD

(71) Applicant: Sony Corporation, Tokyo (JP)

(72) Inventor: Mari Saito, Kanagawa (JP)

(73) Assignee: Sony Corporation, Tokyo (JP)

(21) Appl. No.: 17/265,796

(22) PCT Filed: Jul. 29, 2019
(86) PCT No.: PCT/JP2019/029716

§ 371 Date: Feb. 3, 2021

(30) Foreign Application Priority Data
Aug. 10, 2018 (JP) 2018-150961

(51) Int. Cl. G10L 15/26; G10L 15/22; G06F 3/16

(52) U.S. Cl. CPC G10L 15/26; G06F 3/167; G10L 15/22

(57) ABSTRACT

An instruction relating to a written sentence of an utterance in dictation can be issued satisfactorily.

A display control unit controls displaying of a written sentence of an utterance in dictation. For example, the display control unit displays the written sentence of the utterance to be identifiable for a user who has made the utterance. A giving unit gives an initiative to a predetermined user. For example, the giving unit gives the initiative to the user who has started the dictation. An edit control unit controls such that the user to whom the initiative has been given is able to issue an instruction relating to the written sentence of the utterance. For example, the instruction includes send, decide, complete, register, cancel, clear, and the like.

### TECHNICAL FIELD

The present technology relates to an information processing apparatus and an information processing method, and more particularly, to an information processing apparatus and an information processing method capable of satisfactorily issue an instruction relating to a written sentence of an utterance in dictation.

### BACKGROUND ART

In a case where a plurality of persons conducts the dictation, it is difficult to identify whether the plurality of persons is making an unrelated conversation or alternately conducting the dictation. In addition, the way of saying differs depending on the person. Hence, even when a command is distinguished with accuracy, the recognition result may not always be an intended one due to ambiguities in utterances of users, individual differences in expression, or the like.

For example, PTL 1 discloses that an input voice is divided into a plurality of segments, one or more phonemes are assigned to each segment, one or more words are decided based on the phoneme, one of the words stored in a storage unit is displayed on a monitor as a decided word, and words other than the decided word are set as next candidates of display.

### CITATION LIST

### Patent Literature

[PTL 1]

Japanese Patent Laid-Open No. Hei 11-143487

### SUMMARY

### Technical Problem

In a case where one person conducts the dictation, such one person can determine, for example, whether or not what such one person inputs now is necessary. However, in a case where a plurality of persons conducts the dictation, it is impossible to determine whether or not one person is talking to another one or it is an input to an agent. Further, in a case where the plurality of persons alternately makes an input, since the characteristics and expressions in the utterances are different depending on the person, it may be difficult to correct incorrect recognition or the like with a candidate similar to that in a case where one person makes an input.

The present technology has an object to satisfactorily issue an instruction relating to a written sentence of an utterance in dictation.

### Solution to Problem

A concept of the present technology lies in an information processing apparatus including a display control unit configured to control displaying of a written sentence of an utterance in dictation, a giving unit configured to give an initiative to a predetermined user, and an edit control unit configured to control such that the user to whom the initiative has been given is able to issue an instruction relating to the written sentence of the utterance.

In the present technology, the display control unit controls displaying of the written sentence of the utterance in the dictation. For example, the display control unit may display the written sentence of the utterance in a state in which a user who has made the utterance is identifiable. For example, by displaying in different colors or applying an icon or a symbol, the user who has made the utterance is made in an identifiable state. In addition, the display control unit may display the written sentence of the utterance in an undecided state until a decision is made. For example, blinking, gray characters, or the like is applicable. In this case, for example, the written sentence of the utterance may be decided by a timeout or a decision process.

The giving unit gives an initiative to a user. For example, the giving unit may give the initiative to the user who has started a dictation. In this case, for example, the giving unit may not give the initiative in a case where the user who has started the dictation has a predetermined attribute. This enables prevention of an occurrence of inconvenience due to the initiative to be given to a user having a predetermined attribute. For example, initiative in a case where the user who has started the dictation is equal to or younger than a predetermined age. This enables avoidance of mischief by a child. In addition, in this case, for example, the giving unit may give the initiative to the user depending on a receiver to whom the written sentence of the utterance is sent even in the case where the user who has started the dictation is equal to or younger than the predetermined age. This enables a child to send a message to, for example, a family member.

The edit control unit controls such that the user to whom the initiative has been given is able to issue an instruction relating to the written sentence of the utterance. For example, the instruction relating to the written sentence of the utterance includes send, decide, complete, register, cancel, clear, and the like.

In such a manner, in the present technology, the instruction relating to the written sentence of the utterance can be issued by the user to whom the initiative has been given. Therefore, the user to whom the initiative has been given is able to satisfactorily issue an instruction relating to the written sentence of the utterance in the dictation. For example, even in an environment in which a message is created by a plurality of persons, the user having the initiative is able to create and send the message as the user intends.

### BRIEF DESCRIPTION OF DRAWINGS

FIG. 1 is a block diagram illustrating a configuration example of an information processing apparatus according to an embodiment.

FIG. 2 is a flowchart illustrating an example of a process procedure of a control unit in a case where an utterance of a user occurs.

FIG. 3 is a diagram illustrating an example of a presentation screen in a case of an utterance request mode.

FIG. 4 depicts diagrams each illustrating an example of a presentation screen in a case of a dictation mode.

FIG. 5 depicts diagrams each illustrating an example of a presentation screen in a case of a fuzzy mode.

FIG. 6 depicts diagrams each illustrating an example in a case where a plurality of persons alternately conducts dictation.

FIG. 7 depicts diagrams each illustrating an example in a case of sending a message.

FIG. 8 depicts diagrams for describing a case of timeout (a case of being used by one person).

FIG. 9 depicts diagrams for describing a case of timeout (a case of being used by a plurality of persons).

FIG. 10 depicts diagrams for describing a case of timeout (a case of being used by a plurality of persons and canceled).

FIG. 11 is a diagram for depicting a timeout start point to decide a written sentence.

FIG. 12 depicts diagrams for describing a case of performing a decision process (a case of being used by one person).

FIG. 13 depicts diagrams for describing a case of performing the decision process (a case of being used by a plurality of persons).

FIG. 14 depicts diagrams for describing a case of performing the decision process (a case of being used by a plurality of persons and canceled).

FIG. 15 is a flowchart illustrating an example of a procedure of a dictation mode process in the control unit.

FIG. 16 is a diagram illustrating an example of a sequence in a case where a plurality of users alternately inputs a sentence.

FIG. 17 is a diagram illustrating an example of a sequence in a case of correcting the sentence.

FIG. 18 depicts diagrams for describing utilization of other modalities in a case of being conducted by a plurality of persons.

FIG. 19 is a diagram for depicting utilization of other modalities in a case of being conducted by a plurality of persons.

FIG. 20 is a diagram for depicting utilization of other modalities in a case of being conducted by a plurality of persons.

FIG. 21 is a diagram illustrating an example in which, on a display position of a written sentence relating to an utterance made by a user having an initiative, a written sentence relating to an utterance of another user is merged.

### DESCRIPTION OF EMBODIMENT

Hereinafter, an embodiment for carrying out the invention (hereinafter, referred to as an “embodiment”) will be described. It is to be noted that the description will be given in the following order.

1. Embodiment

2. Modification

### 1. Embodiment

### [Configuration Example of Information Processing System]

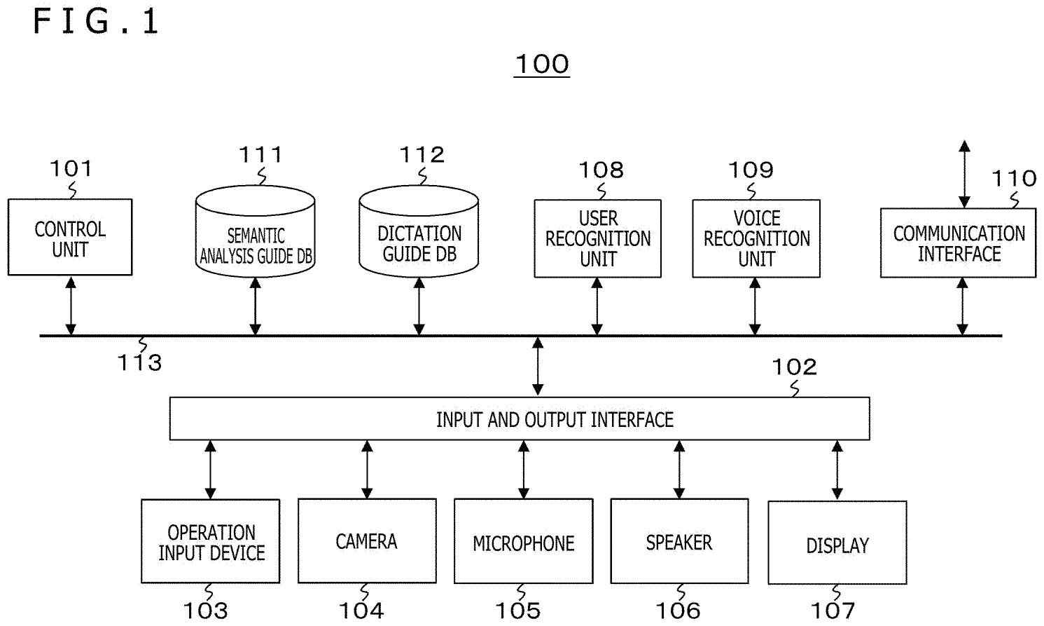

FIG. 1 illustrates a configuration example of an information processing apparatus 100 according to an embodiment. The information processing apparatus 100 constitutes a voice agent. The information processing apparatus 100 includes a control unit 101, an input and output interface 102, an operation input device 103, a camera 104, a microphone 105, a speaker 106, a display 107, a user recognition unit 108, a voice recognition unit 109, a communication interface 110, a semantic analysis guide database 111, and a dictation guide database 112. The control unit 101, the input and output interface 102, the user recognition unit 108, the voice recognition unit 109, the communication interface 110, the semantic analysis guide database 111, and the dictation guide database 112 are connected to a bus 113.

The control unit 101 includes a CPU (Central Processing Unit), a ROM (Read Only Memory), a RAM (Random access memory), and the like and controls operations of each unit of the information processing apparatus 100. The input and output interface 102 connects the operation input device 103, the camera 104, the microphone 105, the speaker 106, and the display 107. The operation input device 103 constitutes an operation unit for performing various operation inputs by an administrator or a user of the information processing apparatus 100. The operation input device 103 also includes a touch panel arranged on a screen of the display 107.

The camera 104 captures an image of, for example, a user on the front side of the information processing apparatus 100 to obtain image data. The microphone 105 detects an utterance of a user to obtain voice data. The speaker 106 outputs a voice as a response output to the user. The display 107 outputs a screen as a response output to the user.

The user recognition unit 108 performs a face recognition process on the image data, detects a face of each user present in an image that is a field of view of the information processing apparatus 100, performs an image analysis process on an image of the detected face of each user, and identifies a user by comparing with a feature amount of each user that has been registered beforehand. Note that it is conceivable that the user recognition unit 108 analyzes the voice data, compares with the feature amount of each user that has been registered beforehand, and identifies the user. In addition, with respect to the user recognition, the user may designate with any recognition means (button operation, voice operation, or the like), even when the user is not automatically recognized.

Further, the user recognition unit 108 performs the image analysis process on the image of each user's face that has been detected and detects the direction of each user's face and the visual line of each user. Further, the user recognition unit 108 performs an analysis process on the image data of each user and detects a finger pointing direction indicating which direction a finger points, in a case where, for example, the user is indicating a direction with the finger. Various types of detection information obtained by the user recognition unit 108 in such manners are sent to the control unit 101.

The voice recognition unit 109 performs a voice recognition process on the voice data to obtain utterance text information. The utterance text information is sent to the control unit 101. The voice text information is held in association with a user, based on user identification information obtained by the user recognition unit 108, as described above. The communication interface 110 communicates with a cloud server, not illustrated, through a network such as the Internet, and obtains various types of information.

The semantic analysis guide database 111 is a database to be referred to in a case where an utterance of a user is in a request utterance mode, such as “tell me the weather for tomorrow,” or “what time is it now?” The dictation guide database 112 is a database to be referred to in a case where an utterance of a user is in a dictation mode, such as “send a message to oo,” “register schedule next month,” or “register ToDo.” Here, the dictation mode is a mode in which an utterance of a user is input into a text as it is, unlike an utterance of a request.

The information processing apparatus 100 illustrated in FIG. 1, determines, whenever a user makes an utterance, whether the utterance is, for example, the request utterance mode or the dictation mode. Then, in a case of the request utterance mode, a request utterance mode process is performed. In a case of the dictation mode, a dictation mode process is performed. In addition, depending on the utterance of the user, it may be impossible to identify which mode the utterance of the user is in. In such a case, a fuzzy mode process corresponding to both modes is performed.

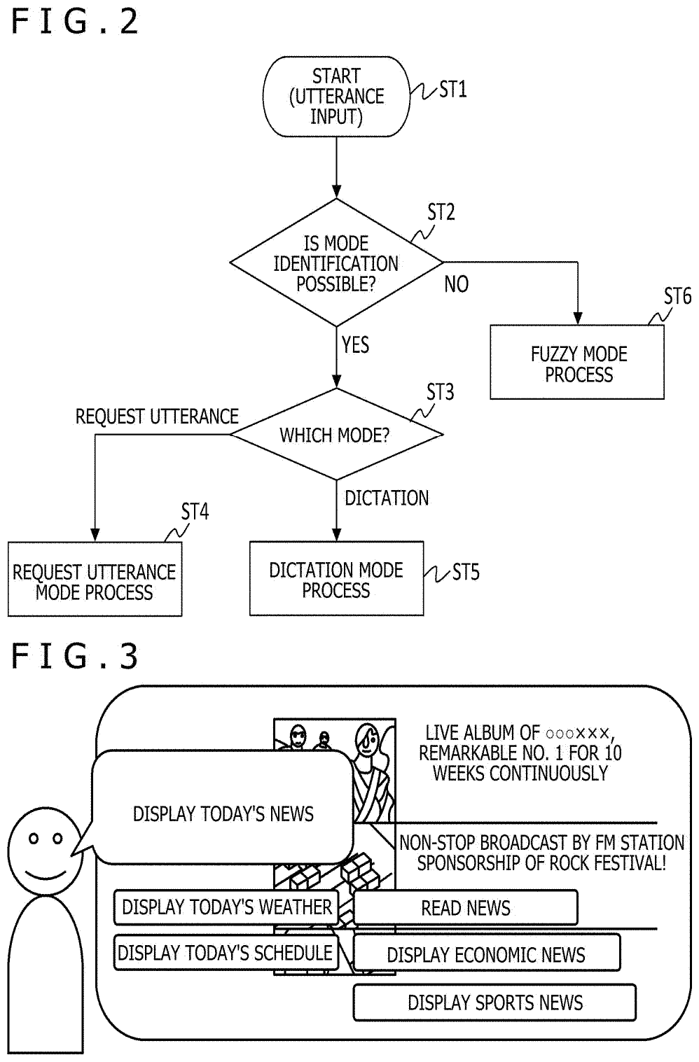

A flowchart of FIG. 2 illustrates an example of a process procedure of the control unit 101 in a case where an utterance of a user occurs. The control unit 101 starts the process when an utterance of a user occurs in step ST1. Next, the control unit 101 determines whether or not mode identification is possible in step ST2. Here, it is also conceivable that the control unit 101 determines whether or not the mode identification is possible from not only contents of the utterance but also operation histories or the like of the user with respect to the contents of the utterance in the past.

In a case where the mode identification is possible, the control unit 101 determines whether the mode corresponding to the utterance of the user is the request utterance mode or the dictation mode in step ST3. In a case of the request utterance mode, the control unit 101 performs the request utterance mode process in step ST4. On the other hand, in a case of the dictation mode, the control unit 101 performs the dictation mode process in step ST5.

In addition, in a case where the mode identification is not possible in step ST2, the control unit 101 performs the fuzzy mode process corresponding to both modes of the request utterance mode and the dictation mode in step ST6.

In the case of the utterance request mode, it is not necessary to write the words one by one precisely. It is sufficient if a command is communicated. In addition, in such a case, only the command may be executed without writing. In a case of incorrect recognition, it is considered that the user desires to know a candidate for re-execution as a command. Therefore, a command similar in a partial match or the like or a related command is presented together with an execution result.

FIG. 3 illustrates an example of a presentation screen in the case of the utterance request mode. This example indicates an example in a case where a user makes an utterance “display today's news.” In the illustrated example, together with the presentation of today's news that is an execution result, similar or related commands are also presented.

In addition, in the case of the dictation mode, when a sentence is not written as the user said, the user desires to correct the sentence. In the case of incorrect recognition, it is considered that the user desires to see candidates for a correction utterance, a partially replaced phrase or a phrase with a symbol such as a question mark “?” is presented.

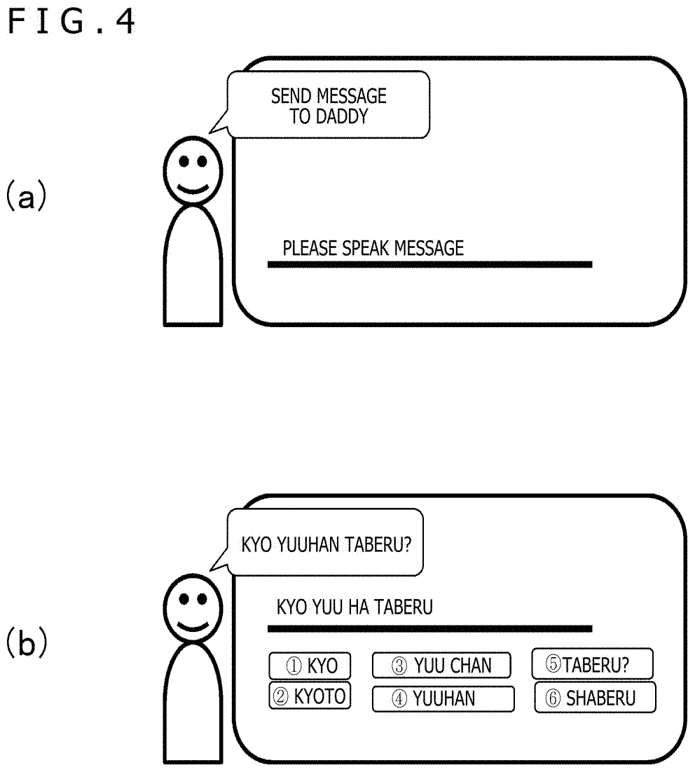

FIG. 4(a) illustrates an example of a first presentation screen in the case of the dictation mode. This example indicates an example of a case where a user makes an utterance “send a message to Daddy.” In the illustrated example, a dictation standby on which a guide display for prompting a user to input a message “please speak a message” is presented.

FIG. 4(b) illustrates an example of a presentation screen in a case where a user actually makes an utterance to input a message according to the guide display. In this example, the user makes an utterance “kyo yuuhan taberu? (“today, will you have a dinner?” in Japanese).” In this case, a written sentence recognized as “kyo Yuu ha taberu (“today, Yuu eat” in Japanese)” is displayed, and conversion candidates for correcting incorrect recognition are also displayed. Here, “kyo” and “kyoto” are displayed each with a number to correspond to “kyo (“today” in Japanese).” In addition, “Yuu Chan” and “yuuhan (“dinner” in Japanese)” are displayed each with a number to correspond to “Yuu ha.” In addition, “taberu? (“eat?” in Japanese)” and “shaberu (“talk” in Japanese)” are displayed each with a number to correspond to “taberu.”

Further, in the case of the fuzzy mode, any of the request utterance and the dictation can be accepted. That is, while executing the request, a dictation standby is presented. In this case, the dictation standby is presented while executing the request such that areas that are separated are displayed on the presentation screen.

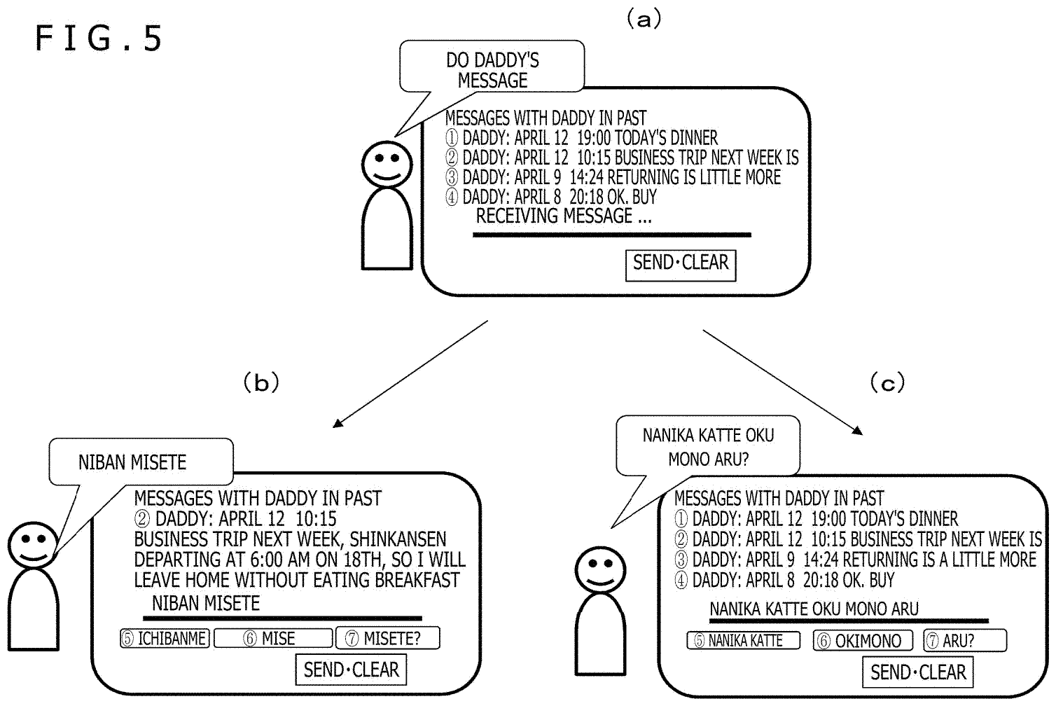

FIG. 5(a) illustrates an example of a first presentation screen in a case of the fuzzy mode. In this example, a user makes an utterance “do Daddy's message.” In this case, it is difficult to identify whether the utterance is a request for browsing a message or creating a message. In the illustrated example, areas are separated to display message item display corresponding to browsing of messages and dictation standby display corresponding to creation of a message.

FIG. 5(b) illustrates an example of a presentation screen in a case where the user desires to browse a message and makes an utterance “niban misete (“display No. 2” in Japanese).” In this case, a written sentence recognized as “niban misete” is also displayed, and conversion candidates for a correction utterance are also displayed each with a number. FIG. 5(c) illustrates an example of a presentation screen in a case where the user desires to create a message and makes an utterance “nanika katte oku mono aru? (“do you want me to buy something?” in Japanese).” In this case, the message item display corresponding to the message browsing is displayed without change, the written sentence recognized as “nanika katte oku mono aru” is displayed, and candidates for a correction utterance are also displayed each with a number.

### “Dictation Mode Process”

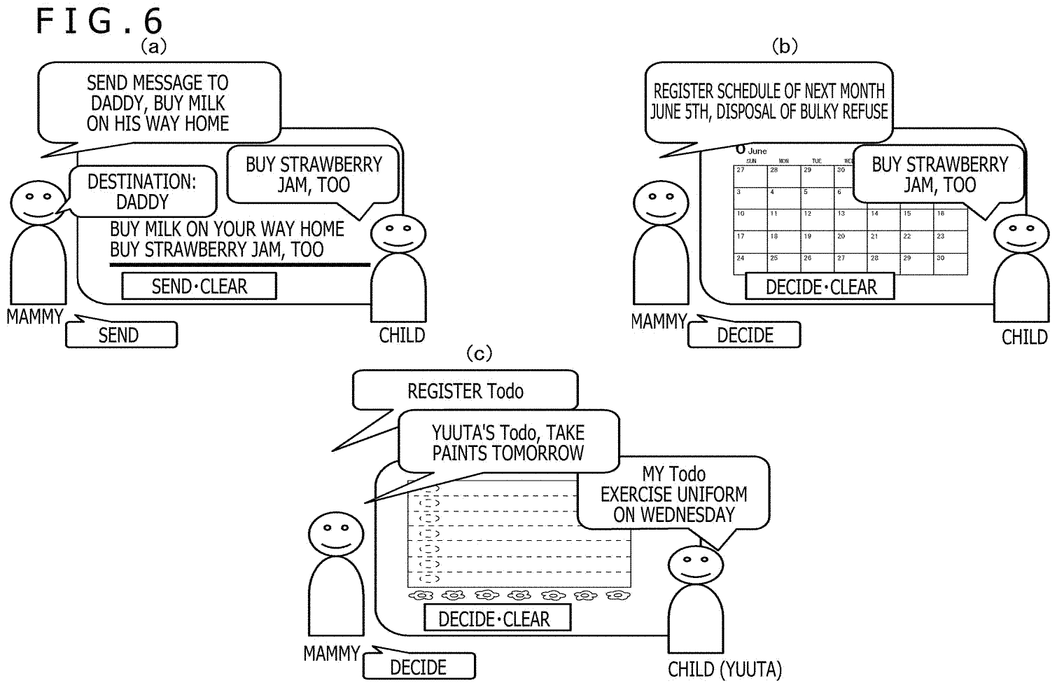

The dictation mode process will be further described. FIGS. 6(a) to 6(c) illustrate examples in a case where dictation is alternately performed by a plurality of persons. FIG. 6(a) is an example in a case of sending a message. In the illustrated example, after Mammy makes an utterance “send a message to Daddy, buy milk on his way home,” a child makes an utterance “buy strawberry jam, too.”

In this case, Mammy makes an instruction utterance of “send.” This causes a message “buy milk on your way home, buy strawberry jam, too” to be sent to Daddy. In a case where “buy strawberry jam, too,” which is an utterance made by the child, is incorrect, the information processing apparatus 100 is not capable of identifying it. Hence, Mammy has to cancel that part intentionally. In addition, in this case, in a case where “buy strawberry jam, too” which is an utterance made by the child is incorrect and then the child makes an instruction utterance “send,” it is also important not to send the message “buy milk on your way home, buy strawberry jam, too.”

FIG. 6(b) illustrates an example in a case of performing calendar registration. In the illustrated example, Mammy makes an utterance “register schedule of next month, June 5th, disposal of bulky refuse,” and then a child makes an utterance “buy strawberry jam, too.” In this case, in a case where “buy strawberry jam, too” which is an utterance made by the child is incorrect, it is necessary for Mammy to cancel that part intentionally and then make an instruction utterance “decide” for registration. In addition, in this case, in a case where “buy strawberry jam” which is the utterance of the child is incorrect and then the child makes an instruction utterance “decide,” “buy strawberry jam, too” on June 5 is also registered mistakenly.

FIG. 6(c) illustrates an example in a case of performing Todo registration. In the illustrated example, Mammy makes an utterance “register Todo” and additionally “Yuuta's Todo, take paints tomorrow,” and then a child (Yuuta) makes an utterance “my Todo, exercise uniform on Wednesday.” In this case, in a case where “my Todo, exercise uniform on Wednesday” which is the utterance of the child is incorrect, it is necessary for Mammy to cancel that part intentionally and then make an instruction utterance “decide” for registration. In addition, in this case, in the case where “my Todo, exercise uniform on Wednesday” which is the utterance of the child is incorrect and then the child makes an instruction utterance “decide,” “take exercise uniform on Wednesday” is registered mistakenly.

As illustrated in the above examples of FIGS. 6(a) to 6(c), it is difficult to determine whether a plurality of persons is conducting dictation or an utterance with no relation is mixed. In the present embodiment, in a case where the information processing apparatus 100 displays a written sentence of an utterance in the dictation on a presentation screen, the user who has made the utterance is displayed in an identifiable state. For example, each user is classified by color, or an icon or a symbol is used to identify which utterance of each user is related to each written sentence.

In addition, in the present embodiment, the user who has started the dictation has an initiative, and only the user having the initiative is able to issue an instruction such as send, decide, complete, register, cancel, and clear so as to prevent mischief or forcible interruption. In this case, in a case where the user who has started the dictation has a predetermined attribute (age, sex, character, ability, or the like), the initiative may not be given. This enables prevention of an occurrence of inconvenience caused by giving the initiative to a user having a predetermined attribute.

In this case, an utterance, an external sound, or the like that has been input unintentionally is subject to dictation, but is not executed. Therefore, this is not critical. In addition, as long as a decision process is not performed, temporary input information (for example, blinking, gray characters, or the like) may be set to provide a timeout to the decision process. Further, in a case where a child or the like possibly conducts mischief, the initiative may be given to an adult only. In this case, for example, in a case where a user who has started the dictation is equal to or younger than a predetermined age, the initiative is not given. Furthermore, for example, the process of the initiative may be changed depending on the person such that, in a case where a receiver is a family member, a child is also allowed to send. In this case, for example, depending on the receiver to whom the written sentence of the utterance is to be sent, the initiative is given even in the case where the user who has started the dictation is equal to or younger than a predetermined age.

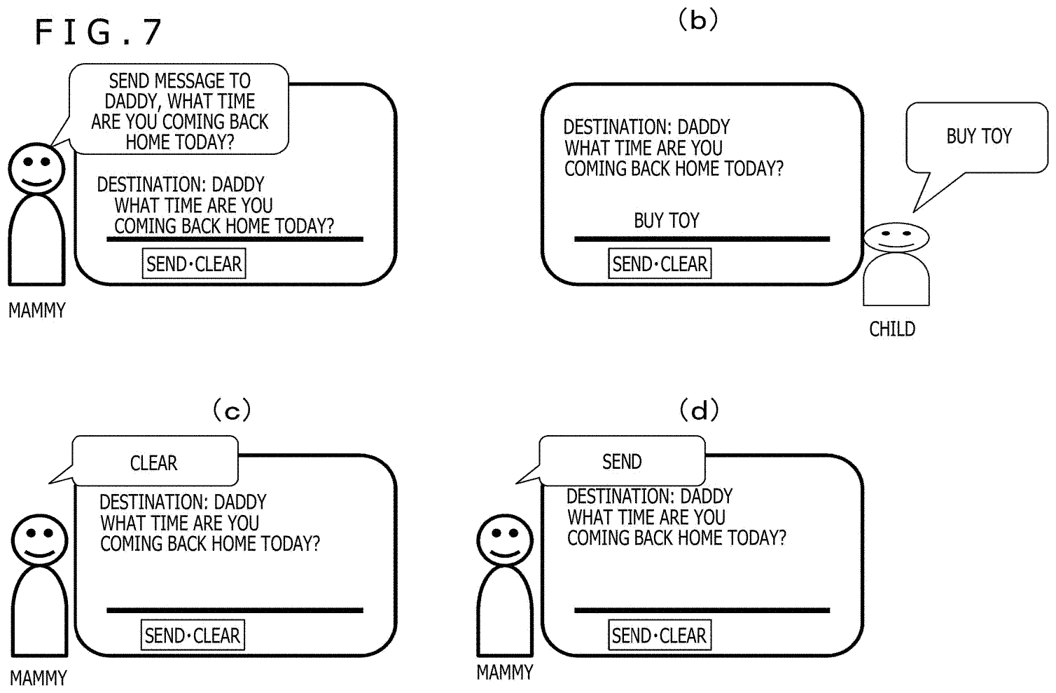

For example, FIGS. 7(a) to 7(d) illustrate examples in a case of sending a message. In FIG. 7(a), a presentation example is illustrated such that Mammy makes an utterance “send a message to Daddy, what time are you coming back home today?” In this case, a written sentence recognized as “what time are you coming back home today?” is displayed in an undecided state. In this case, Mammy has the initiative for an instruction including send, decide, complete, register, cancel, clear, and the like, because Mammy is the user who has started the dictation.

FIG. 7(b) illustrates a presentation example in a case where the written sentence “what time are you coming back home today?” is decided by a decision instruction from Mammy or a timeout, and then the child makes an utterance “buy a toy.” In this case, a written sentence recognized as “buy a toy” is displayed in an undecided state. Here, the undecided state is displayed by, for example, blinking or gray characters.

FIG. 7(c) illustrates a presentation example in a case where Mammy makes an instruction utterance “clear.” In this case, the written sentence “buy a toy” in the undecided state is canceled. It is to be noted that, even after the part “buy a toy” is decided by a timeout, the part can be canceled by designating the part.

In addition, in this case, the part “what time are you coming back home today?” and the part “buy a toy” are displayed so that the users that have made the respective utterances are identifiable, for example, in different colors. By displaying to be identifiable in such a manner, it is convenient to, for example, designate the part to be canceled. FIG. 7(d) illustrates a presentation example in a case where Mammy makes an instruction utterance “send.” In this case, the message “what time are you coming back home today?” is sent to Daddy.

It is to be noted that, in the above description, the example of canceling the utterance input by the child has been illustrated. However, in a similar manner, a meaningless written sentence due to incorrect recognition of an external sound or the like can be an utterance input. Also in such a case, the user having the initiative is able to delete the written sentence by making an instruction utterance “clear.” In addition, also in a case of being used in business or the like, it can be used as an application that gives the initiative to a person having a specific authority only.

Here, session management of inputs in the dictation mode will be described. In a case where a user who is making an utterance input in dictation is present, another user is able to make an utterance input additionally, without starting a new session in particular. In this case, in the case where a user who is making the utterance input is present, another user near the user who is making the utterance input is detected, and the utterance input of the another user is additionally written. In addition, in a case where it is clearly understood that it is not an additional utterance input from information regarding the face direction or the like of the another user, the utterance input is not written. By conducting the session management in such a manner, a user who performs an additional utterance input later does not have to mention a starting word, and each user is able to alternately make an utterance input.

Next, a decision process in the dictation mode will be described. A termination of an utterance is detected, and the decision process is performed for each termination. Such a decision process is performed by the user having the initiative making an instruction utterance “decide” or by a timeout due to the lapse of a certain period of time after the termination is detected. For example, an interruptive utterance can be cleared before the timeout at each termination. In a case of not being cleared, it is decided at the timeout or a decision utterance.

The utterance input continues as it is even when there is an utterance termination until the user decides the utterance. In this case, in a case where a part is desired to be cleared, the part to be decided is designated and then decided. For example, the part to be decided can be designated by making an utterance “decide including “coming back home?”” or “send including “coming back home?”” In addition, by designating the part desired to be cleared, clear is executed. For example, by making an utterance “buy,” a part continuous from “buy” (buy and later) is cleared. Further, for example, by making an utterance “buy a toy,” “buy a toy” as a whole is cleared.

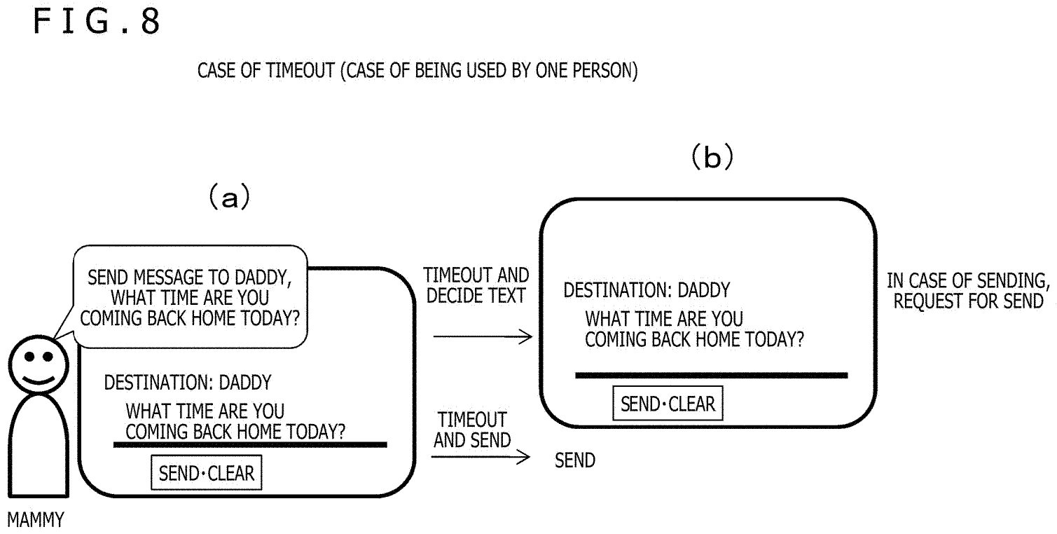

Here, by using FIGS. 8(a) and 8(b), a case of timeout (a case of being used by one person) will be described. FIG. 8(a) illustrates a presentation example in a case where Mammy makes an utterance “send a message to Daddy, what time are you coming back home today?” In this case, a written sentence recognized as “what time are you coming back home today?” is displayed in an undecided state. In this state, when a certain period of time, for example, four seconds elapses, a timeout is determined. As illustrated in FIG. 8(b), the written sentence “what time are you coming back home today?” is in a decided state.

Then, in the state illustrated in FIG. 8(b), Mammy makes an instruction utterance “send,” and then the message “what time are you coming back home today?” is sent to Daddy. It is to be noted that, as illustrated in the drawing, in the case of timeout from the state of FIG. 8(a), it is also conceivable that the written sentence “what time are you coming back home today?” is decided and the message “what time are you coming back home today?” is sent to Daddy immediately.

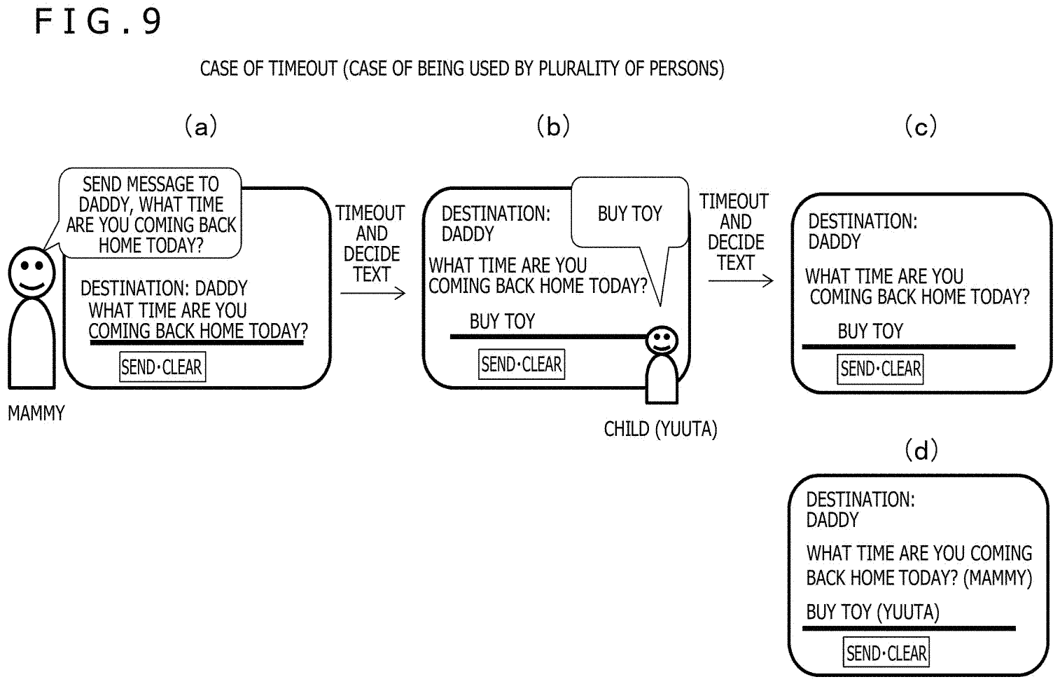

Next, by using FIGS. 9(a) to 9(d), a case of timeout (a case of being used by a plurality of persons) will be described. FIG. 9(a) illustrates a presentation example in a case where Mammy makes an utterance “send a message to Daddy, what time are you coming back home today?” In this case, a written sentence recognized as “what time are you coming back home today?” is displayed in an undecided state.

In this state, when a certain period of time, for example, four seconds elapses, a timeout is determined. As illustrated in FIG. 9(b), the written sentence “what time are you coming back home today?” is in a decided state. In this state, as illustrated in the drawing, in a case where a child (Yuuta) makes an utterance “buy a toy,” the written sentence of this utterance is displayed in an undecided manner. In this state, when a certain period of time, for example, four seconds elapses, a timeout is determined. As illustrated in FIG. 9(c), the written sentence “buy a toy” is also in the decided state.

In this case, the utterance part of Mammy “what time are you coming back home today?” and the utterance part of the child “buy a toy” are displayed so that which users have made the respective utterances are identifiable, for example, in different colors. It is to be noted that, instead of using different colors, the user can also be identified by an icon or a symbol. For example, FIG. 9(d) illustrates an example in which users that have made the respective utterances are identifiable by applying their names to the respective utterances. It is to be noted that, in the state of FIG. 9(c) or FIG. 9(d), Mammy makes an instruction utterance “send,” and then the message “what time are you coming back home today? Buy a toy” is sent to Daddy.

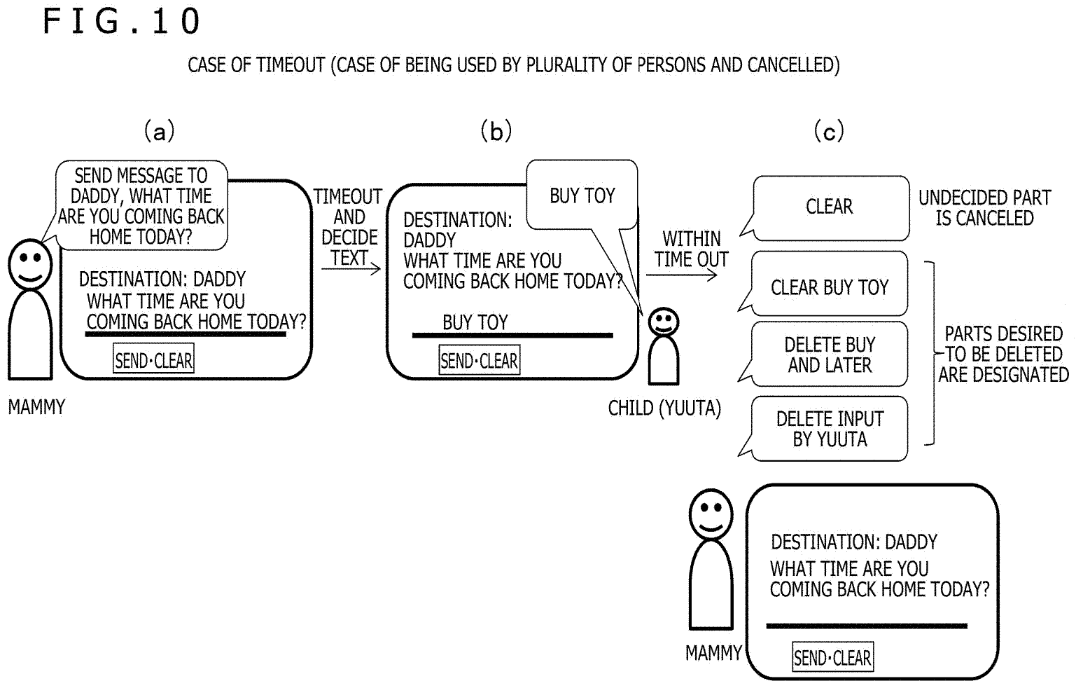

Next, by using FIGS. 10(a) to 10(c), a case of timeout (a case of being used by a plurality of persons and canceled) will be described. Detailed descriptions will be omitted, but FIG. 10(a) and FIG. 10(b) are respectively the same as FIG. 9(a) and FIG. 9(b).

Mammy who has started dictation has the initiative. In the state of FIG. 10(b), by making an instruction utterance “clear,” an undecided part can be canceled. Here, as a result, as illustrated in FIG. 10(c), the written sentence “buy a toy” is canceled. It is to be noted that, in this case, with respect to the undecided part, a part to be desired to be canceled can be directly designated. For example, by making an instruction utterance “buy a toy, clear,” “buy and later, clear,” “delete the input by Yuuta,” or the like, the written sentence “buy a toy” can be canceled.

It is to be noted that, in the example of FIG. 10, after the utterance part of Mammy “what time are you coming back home today?” is decided by a timeout, the utterance “buy a toy” which is an utterance part of the child is made, and the written sentence is displayed in the undecided manner. However, it can be assumed that before an utterance of a certain user is timed out, the next user starts making an utterance. In such a case, with respect to the utterance of the certain user, the timeout starts from the termination of the utterance of the next user. Both the utterance of the certain user and the utterance of the next user are in the undecided state. In such a case, a cancellation process can be performed on the undecided written sentences of both utterances.

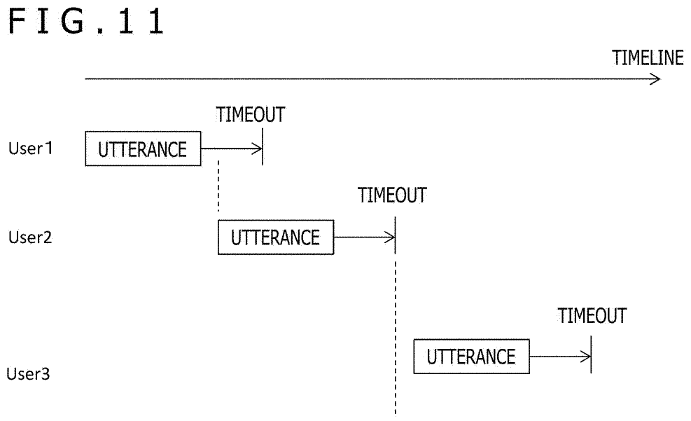

FIG. 11 is a diagram for depicting a timeout start point for deciding a written sentence. In FIG. 11, regarding an utterance of a user 1, the end (termination) of the utterance becomes a timeout start point. However, when an utterance of a user 2 starts before the timeout of the utterance of the user 1, the timeout of the user 1 is canceled, and the end (termination) of the utterance of the user 2 becomes a new timeout start point. Therefore, the utterance of the user 1 and the utterance of the user 2 are both in the undecided state until the timeout is reached from the end (termination) of the utterance of the user 2. In addition, since an utterance of a user 3 starts after the timeout, the utterance of the user 3 is processed as a new utterance.

It is to be noted that, in the above description, the user having the initiative is able to perform the cancellation process in the state where the written sentence of the utterance input is in an undecided state. However, in such a state, each user is also able to perform a correction process on the sentence. Also in this case, the final decision of the correction process on the sentence can be performed by the user having the initiative.

In addition, in a case where a process such as cancellation or sentence correction is performed its time point is set as a new timeout process start point, for example. Accordingly, even in a case where a user performs a plurality of processes such as the cancellation and sentence correction, the user is able to perform the processes with an enough time.

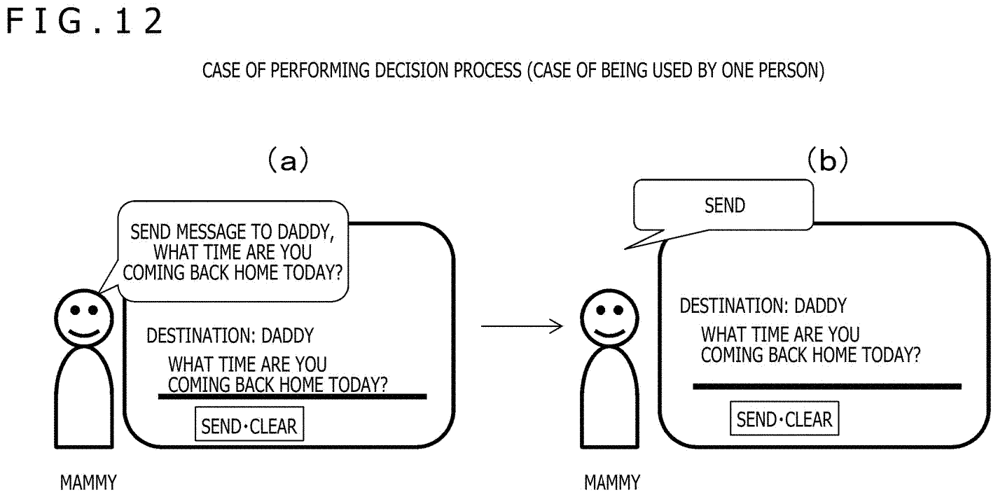

Further, by using FIGS. 12(a) and 12(b), a description will be given of a case of performing a decision process (in a case of being used by one person uses). FIG. 12(a) illustrates a presentation example in a case where Mammy makes an utterance “send a message to Daddy, what time are you coming back home today?” In this case, a written sentence recognized as “what time are you coming back home today?” is displayed in an undecided state. In this state, Mammy is able to perform a clear process and a correction process on the sentence.

Then, Mammy makes an instruction utterance “send.” Then, as illustrated in FIG. 12(b), the written sentence “what time are you coming back home today?” is decided, and the message “what time are you coming back home today?” is sent to Daddy. It is to be noted that, in the illustrated example, the instruction utterance “send” instructs the decision of the written sentence and sending of the written sentence. However, it is also conceivable that the decision of the written sentence is instructed by, for example, an instruction utterance “decision,” and then the sending is instructed by an instruction utterance “send.”

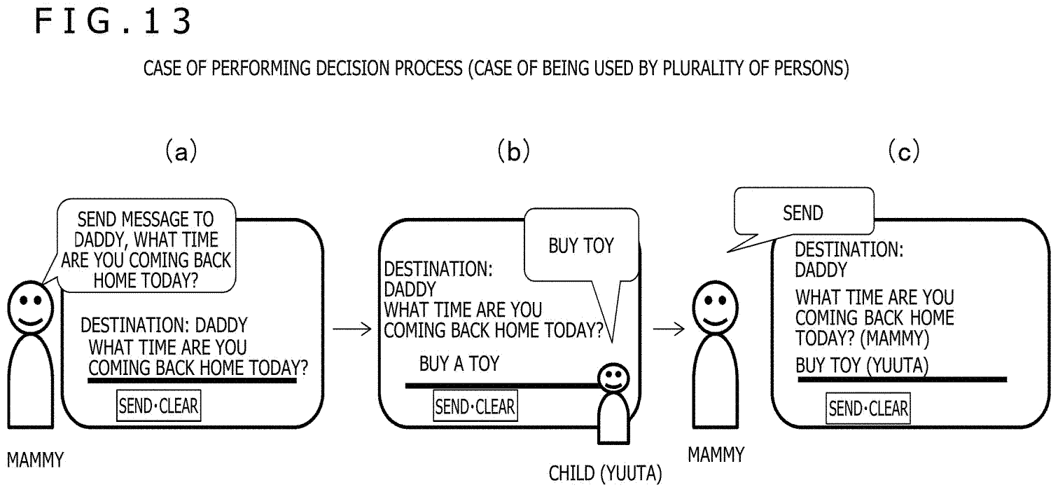

Next, by using FIGS. 13(a) to 13(c), a description will be given of a case of performing the decision process (in a case of being used by a plurality of persons). FIG. 13(a) illustrates a presentation example in a case where Mammy makes an utterance “send a message to Daddy, what time are you coming back home today?” In this case, a written sentence recognized as “what time are you coming back home today?” is displayed in an undecided state.

In this state, as illustrated in FIG. 13(b), in a case where a child (Yuuta) makes an utterance “buy a toy,” the written sentence is additionally displayed in an undecided state. In this state, Mammy having the initiative is able to perform a clear process and a sentence correction process. It is to be noted that, although the child (Yuuta) is also able to perform the correction process on the sentence, the child does not have the initiative. Therefore, Mammy performs a process for final correction decision.

Then, Mammy having the initiative performs an instruction utterance “send,” as illustrated in FIG. 13(c), a written sentence “what time are you coming back home today? (Mammy) Buy a toy (Yuuta)” is decided, and a message “what time are you coming back home today? Buy a toy (Yuuta)” is sent to Daddy. It is to be noted that, in the illustrated example, the instruction utterance “send” instructs the decision of the written sentence and sending of the written sentence. However, it is also conceivable that the decision of the written sentence is instructed by, for example, an instruction utterance “decision,” and then the sending is instructed by an instruction utterance “send.”

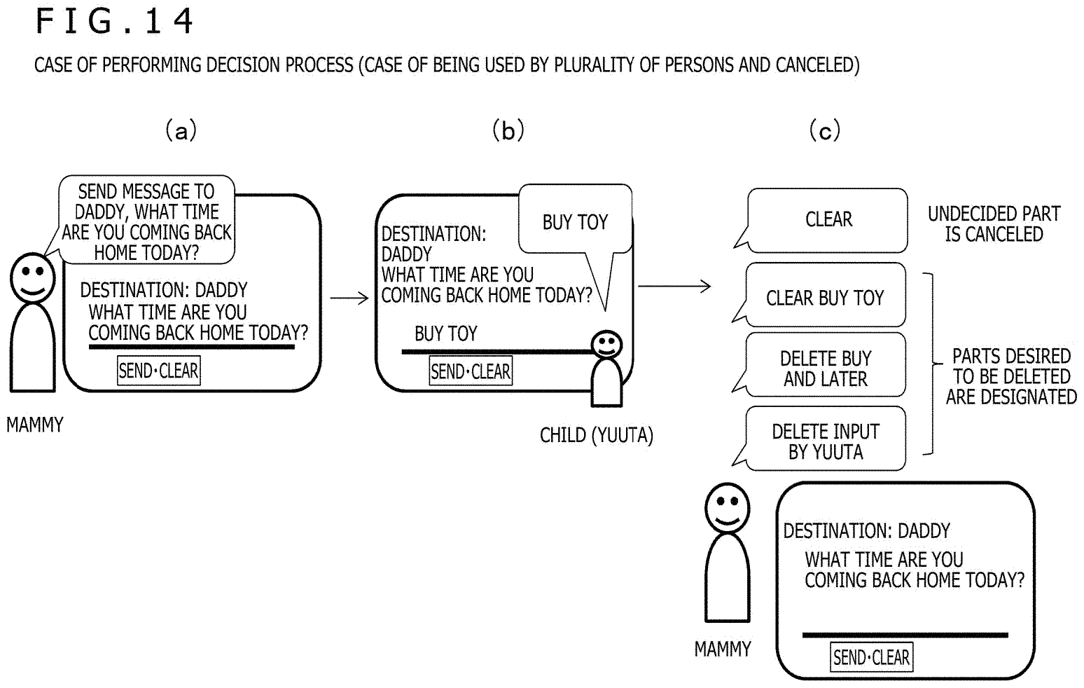

Next, by using FIGS. 14(a) to 14(c), a description will be given of a case of performing the decision process (in a case of being used by a plurality of persons and canceled). Detailed descriptions will be omitted, but FIG. 14(a) and FIG. 14(b) are respectively the same as FIG. 13(a) and FIG. 13(b).

Mammy who has started dictation has the initiative. In the state of FIG. 14(b), Mammy makes an instruction utterance “clear,” so as to be able to cancel an undecided part. In addition, in this case, with respect to the undecided part, a part to be desired to be canceled can be directly designated. For example, by making an instruction utterance “buy a toy, clear,” “buy and later, clear,” “delete the input by Yuuta,” or the like, the written sentence “buy a toy” can be canceled. FIG. 14(c) illustrates a state in which the written sentence “buy a toy” has been canceled.

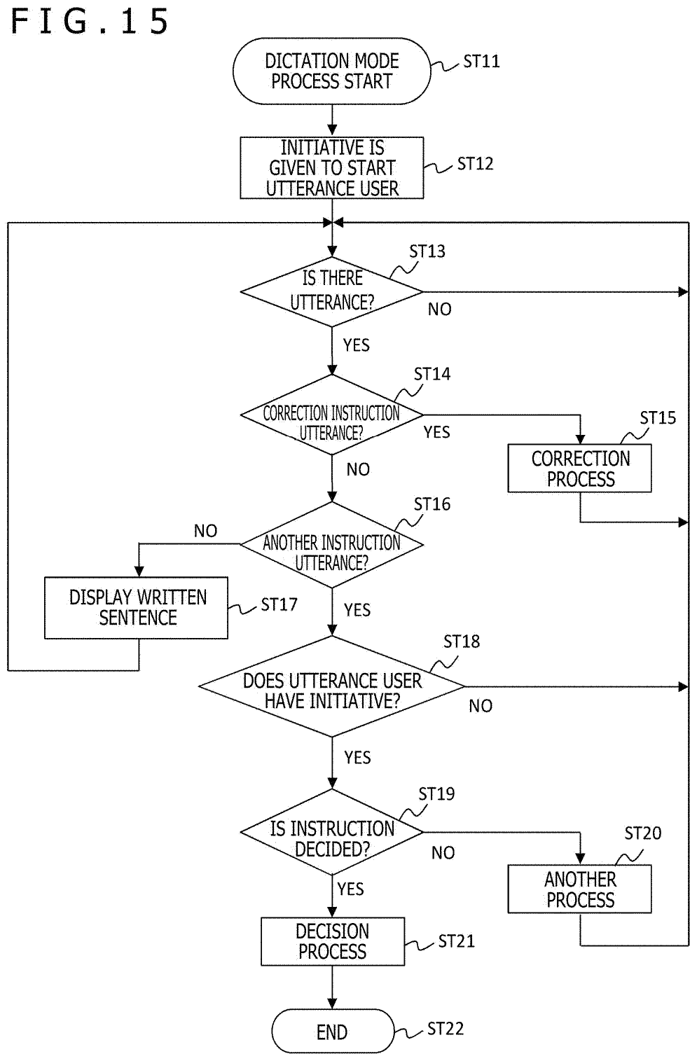

A flowchart of FIG. 15 illustrates an example of a procedure of the dictation mode process (see step ST5 in FIG. 2) in the control unit 101 of the information processing apparatus 100. It is to be noted that user identification, that is, an identification process of an utterance user is always performed in another process flow.

First, the control unit 101 starts the dictation mode process in step ST11. Next, the control unit 101 gives an initiative to a start utterance user in step ST12. Next, the control unit 101 determines whether or not there is an utterance in step ST13.

In a case where there is an utterance, the control unit 101 determines whether or not the utterance is a correction instruction utterance in step ST14. In a case where the utterance is the correction instruction utterance, the control unit 101 performs a correction process on a written sentence in step ST15, and then returns to the process of step ST13.

In a case where the utterance is not the correction instruction utterance, the control unit 101 determines whether or not the utterance is another instruction utterance other than the correction instruction, such as “clear,” “decide,” “register,” “send,” or “correct,” in step ST16. In a case where the utterance is not another instruction utterance, the control unit 101 displays the written sentence corresponding to the utterance on the display 107 in step ST17, and then returns to the process of step ST13.

In a case where the utterance is another instruction utterance in step ST16, the control unit 101 determines whether or not an utterance user has the initiative in step ST18. In a case where the utterance user does not have the initiative, the another instruction utterance is made invalid, and the control unit 101 returns to the process of step ST13.

In a case where the utterance user has the initiative in step ST18, the control unit 101 determines whether or not the instruction is a decision (send, register, or the like) in step ST19. In a case where the instruction is not a decision (send, register, or the like), the control unit 101 performs a process other than the decision (send, register, or the like) in step ST20, and then returns to the process of step ST13.

On the other hand, in a case where the instruction is a decision (send, register, or the like), the control unit 101 performs a decision process (send, register, or the like) in step ST21, and then ends a series of processes in step ST22.

A case where a plurality of users desires to conduct different tasks will be described. In this case, the information processing apparatus 100 regards as alternate utterances in a case where a domain (intent) and a slot (entity) are the same. Here, the domain means, for example, sending of a message, calendar registration, ToDo registration, and the like. In addition, the slot means, for example, a destination in a case of a domain in sending of the message, means a date and the like in a case of the calendar registration, and means an target person in a case of the ToDo registration. Therefore, the case where the domain and the slot are the same corresponds to a case where destinations in sending a message are the same, a case where dates in the calendar registration are the same, and a case where target persons in the ToDo registration are the same, or the like.

It is to be noted that, even in a case where the slots are different, as long as the domains are the same and the display is possible, the information processing apparatus 100 performs a process on an identical screen. Further, in a case where the domains are different, the information processing apparatus 100 divides a screen, performs a process in a presenting manner, or performs a process by substituting a voice output for a domain which cannot be displayed in a divided manner. For example, it is conceivable that in a case of performing a message sending task based on an utterance of Mammy “send a message to Daddy” and performing a request task based on an utterance of a child “display the weather,” the message sending task is performed on a screen, but regarding the weather, the weather is communicated to the child by voice.

A conversion candidate for a written sentence will be described. As described above, in the dictation mode process, a written sentence of an utterance in the dictation is displayed. In this case, a conversion candidate for a correction utterance of incorrect recognition is displayed.

How to present the conversion candidate will be described. Basically, priority is given to similar sound candidates as compared to candidates of notation variant (for example, whether a character is converted into a Japanese Kanji character or remains in a Japanese Hiragana character, whether a number is represented in a Japanese Kanji character or an Arabic numeral, and the like). This is because, with respect to the notation variant, even if it is included, its meaning can make sense. It is to be noted that a notation variant candidate can be presented to a user who is particular about the notation variant. In addition, only Japanese Hiragana characters can be presented to a child user. Whether or not a user is particular about the notation variant may be determined based on a personality attribute database of the user, or may be determined based on correction history information of the user in the past. Further, whether or not a user is a child can be determined based on user recognition results.

Regarding how to present the conversion candidate, a history is utilized to present for each utterance user. In this case, in a case where there is no similar sound candidate in the history of the target user, the history of another user such as a family member can be referred to. In this case, a candidate similar to the utterance is presented as a candidate from among the utterance input sentences of the target user in the past or from among the sentences used by another user in the past. In addition, in this case, a candidate suitable for a context, or a place, time, situation, and the like is presented with priority.

Next, how to designate for correction will be described. In a case where identical utterances are input, the utterance part is determined to be incorrect recognition, and a conversion candidate is changed to be different from the previous one. For example, in a case where a first utterance is “have a dinner,” a second utterance (correction utterance) is “have a dinner,” and a first written sentence is “have a dinner,” a second written sentence is corrected to, for example, “have a dinner?” which is different from the first one.

In addition, in a case where a correction utterance “xx instead of oo” is made, the corresponding part “oo” in the written sentence is corrected to “xx.” For example, consideration is given to a case where, in response to an utterance input “yuuhan taberu? (“have a dinner?” in Japanese),” a written sentence that has been recognized is “Yuu ha taberu (“Yuu eat” in Japanese).” In this case, in a case where a correction utterance “yuuhan instead of Yuu ha” is made, the part “Yuu ha” is corrected to “yuuhan.”

In addition, correction of the written sentence is conducted by a correction utterance of a conversion candidate only or the designation of the number of the conversion candidate. For example, consideration is given to a case where, in response to an utterance input “yuuhan taberu?,” a written sentence that has been recognized is “Yuu ha taberu.” In this case, in a case where a correction utterance “yuuhan” is made, correction is made to “yuuhan taberu.”

In addition, with respect to the written sentence of an utterance of a certain user, a correction utterance made by another user is also processed equally with a correction utterance made by the certain user. This enables another family member to make a correction utterance, in a case where the certain user's voice is hardly entered.

Correction in a case of alternately inputting a long sentence will be described. In this case, a sentence that has been input can be corrected. That is, while a certain user is inputting the next sentence, another user is able to correct a previous sentence. In this case, an utterance and an already input sentence are compared with each other. In a case where the similarity is equal to or more than a certain ratio, the utterance is regarded as an input of a correction sentence and a correction is made. In this case, the corrected part may be indicated so as to be understood by another user other than the user who has made the correction, for example, a user who is inputting the next sentence.

In addition, in this case, the sentence that has been input by a certain user can also be corrected by another user. In this case, the utterance and the already input sentence are compared with each other. In a case where the similarity is equal to or more than a certain ratio, the utterance is regarded as an input of a correction sentence. After the certain user confirms, the correction is decided. This prevents a correction of a sentence of a certain user from being corrected by another user without permission.

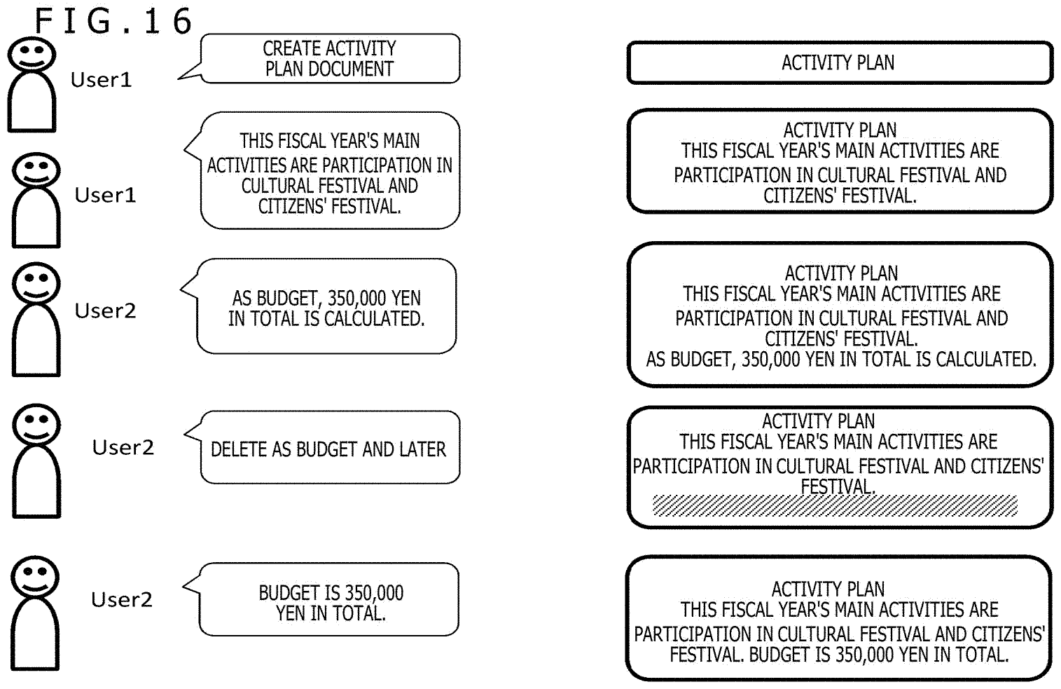

FIG. 16 illustrates an example of a sequence in a case where a plurality of users alternately inputs sentences. Here, the plurality of users includes two users who are a user 1 and a user 2. First, a dictation mode process for creating an activity plan document is started by an utterance input of the user 1 “create an activity plan document,” and the “activity plan” is displayed as a written sentence.

Next, by an utterance input of the user 1 “this fiscal year's main activities are participation in cultural festival and citizens' festival,” a written sentence corresponding to the utterance input is added. Next, by an utterance input of the user 2 “as budget, 350,000 yen in total is calculated,” a written sentence corresponding to the utterance input is added.

Next, according to an instruction utterance input of the user 2 “delete as budget and later,” as budget and later is deleted from the written sentence. In this case, the deletion is indicated so as to be understood by the user 1 (see the hatched part). Next, by an utterance input of the user 2 “budget is 350,000 yen in total,” a written sentence corresponding to the utterance input is added. In this case, the added part is displayed to be different in color from the other parts so that the user 1 understands the added part.

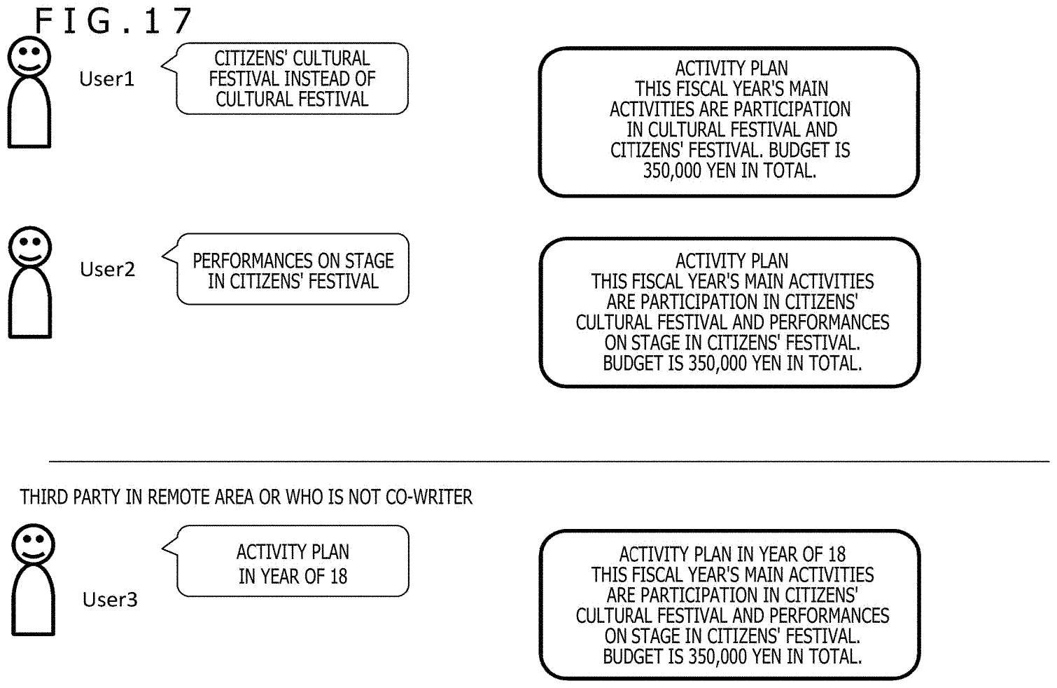

FIG. 17 illustrates an example of a sequence in a case of correcting sentences that have been input, as illustrated in FIG. 16 described above. First, by an utterance input for a correction instruction of the user 1 “citizens' cultural festival instead of cultural festival,” the part “cultural festival” is corrected to “citizens' cultural festival.” In this case, the corrected part is displayed to be different in color from the other parts so that the user 2 understands the corrected part. It is to be noted that, in FIG. 17, the difference in color is not illustrated because of a black-and-white drawing. Similar facts apply to the following description.

Next, by an utterance input of the user 2 for a correction instruction “performances on stage in citizens' festival,” the part of “citizens' festival” is corrected to “performances on stage in citizens' festival.” Also in this case, the corrected part is displayed to be different in color from the other parts so that the user 1 understands the corrected part. In this case, the input part of another user, which is not the user's, is corrected, and the corrected part becomes more noticeable.

Next, by an utterance input of a third party in a remote area or who is not a co-writer “activity plan in the fiscal year of 18,” the part “activity plan” is corrected to “activity plan in the fiscal year of 18.” In this case, the third party corrects the input part of the user, and the corrected part becomes more noticeable. It is to be noted that such a notice can be made, for example, in a special color. However, in FIG. 17, the difference in color is not illustrated because of a black-and-white drawing.

Utilization of other modalities in a case of being performed by a plurality of persons will be described. Use of an instruction word and a position will be described. For example, it is conceivable to select a conversion candidate corresponding to an utterance such as “change to a middle one” for correction, on the basis of the position of a user who is making an utterance. In addition, for example, it is conceivable to detect a standing position of each user, select a conversion candidate that is relatively close in response to an utterance “this,” and select a conversion candidate that is relatively distant in response to “that” so as to make a correction.

Use of a hand, a gesture, and a visual line will be described. By making an utterance “correct to this,” “change to this,” or the like, while pointing with a finger, touching, or the like to designate a conversion candidate, a correction is made by the conversion candidate that has been designated.

Further, a conversion candidate is selected in combination of an utterance and touching or the like to make a correction. For example, consideration is given to a case where, in response to an utterance input of a user “kaerini juunanzai kattekite (“buy a softening agent on your way home” in Japanese),” a written sentence that has been recognized is “kaerini juumankai kattekite (“buy ten thousand times on your way home” in Japanese),” and conversion candidates (1) juumankai (“ten thousand” in Japanese), (2) juunanzai (“a softening agent” in Japanses), and (3) juunansai (“a teenage” in Japanese) are presented. In this case, by making a second utterance “buy (touch (2)) on your way home” or “buy (2) on your way home,” (2) a softening agent is selected as the conversion candidate and a correction is made.

It is to be noted that, in a case where a plurality of users makes utterances, it is conceivable that a conversion candidate is presented to be close to a user who is currently making an utterance so as to be easily visible and easily touched. In addition, it is conceivable that in a written sentence, by presenting only a conversion candidate relating to the part on which the user's visual line stays, the user is able to select the conversion candidate with accuracy.

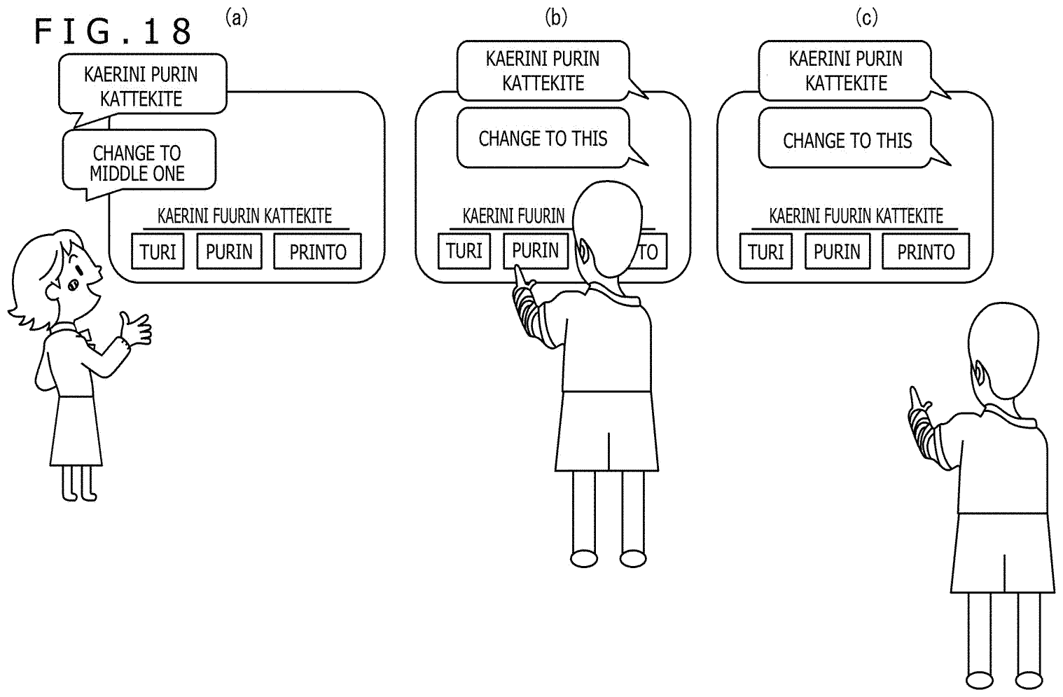

FIG. 18(a) is a presentation example in which, in response to an utterance input of a user “kaerini purin kattekite (“buy pudding on your way home” in Japanese),” a written sentence that has been recognized is “kaerini fuurin kattekite (“buy a wind chime on your way home” in Japanese)” and conversion candidates “turi (“fishing” in Japanese),” “purin (“pudding” in Japanese),” and “printo (“print” in Japanese)” are presented side by side in this order in the horizontal direction on the screen. Then, in such a state, this example illustrates a case where an utterance “change to the middle one” is made by a user. In this case, the conversion candidate “purin” is selected, and the part “fuurin” is corrected to “purin.”

FIG. 18(b) is a presentation example in which, in response to an utterance input of a user “kaerini purin kattekite,” a written sentence that has been recognized is “kaerini fuurin kattekite” and conversion candidates “turi,” “purin,” and “printo” are presented side by side in this order in the horizontal direction on the screen. Then, in such a state, this example illustrates a case where a user touches the presenting part of the selection candidate “purin” and makes an utterance “change to this.” Also in this case, the conversion candidate “purin” is selected, and the part “fuurin” is corrected to “purin.”

FIG. 18(c) a presentation example in which, in response to an utterance input of a user “kaerini purin kattekite,” a written sentence that has been recognized is “kaerini fuurin kattekite” and conversion candidates “turi,” “purin,” and “printo” are presented side by side in this order in the horizontal direction on the screen. Then, in such a state, this example illustrates a case where a user points with a finger the presenting part of the selection candidate “purin” and makes an utterance “change to this.” Also in this case, the conversion candidate “purin” is selected, and the part “fuurin” is corrected to “purin.”

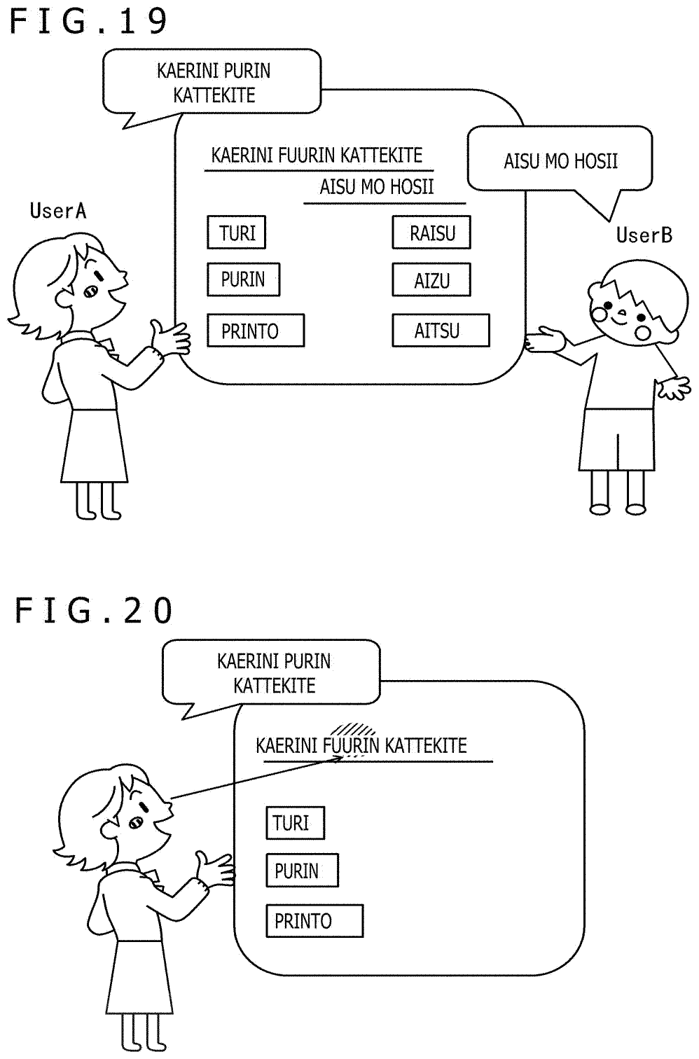

In FIG. 19, in response to an utterance input of a user A “kaerini purin kattekite,” a written sentence recognized as “kaerini fuurin kattekite” is displayed. In addition, in response to an utterance input of a user B “aisu mo hosii (“want ice cream, too” in Japanese),” a written sentence recognized as “aisu mo hosii” is displayed. A conversion candidate for the written sentence “kaerini fuurin kattekite” relating to the utterance input of the user A is displayed near the user A. On the other hand, a conversion candidate for the written sentence “aisu hosii (“want ice cream” in Japanese)” relating to the utterance input of a user B is displayed near the user B.

Note that it is also conceivable that a conversion candidate for correcting the written sentence of the utterance made by each user can be given by voice instead of the screen display. Also in such a case, the voice can be given to the user so that only the user can hear the voice.

In FIG. 20, in response to an utterance input of the user A “kaerini purin kattekite,” a written sentence recognized as “kaerini fuurin kattekite” is displayed. In this case, a conversion candidate relating to the “fuurin” part is presented by detecting the user's visual line staying on the part “fuurin” (indicated by hatching). In the illustrated example, “turi,” “purin,” and “printo” are presented. It is to be noted that not only staying of the visual line but also movements of the visual line, such as alternately looking at an incorrect recognition part and a candidate used for correction, may be detected.

Control by a display area will be described. In a case where a certain amount of the display area can be used, it is conceivable to display the whole text by emphasizing a difference between the candidates as the conversion candidates. In addition, in a case where the display area is small, it is conceivable to display only a part where a change is made. Further, for example, in a case where there is no display, it is conceivable to repeat by voice, and after only a part to be corrected is corrected, the corrected part is repeated. It is to be noted that the case where there is no display corresponds to, for example, a wearable device of a watch type, an earphone type, or the like.

As described heretofore, in the information processing apparatus 100 illustrated in FIG. 1, in the dictation mode process, an initiative is given to a user who has started the dictation, and only the user to whom the initiative has been given is able to issue instructions such as “clear,” “decide,” “register,” and “send.”. Therefore, the user to whom the initiative has been given is able to satisfactorily issue an instruction relating to a written sentence of an utterance in the dictation, and, for example, even in an environment in which a message is created by a plurality of persons, the user having the initiative is able to create and send the message as the user intends.

### 2. Modification

It is to be noted that in the above-described embodiment, the request utterance mode and the dictation mode have been described. However, a mixed mode is also conceivable such that a request part and a dictation part are identified from an utterance and an appropriate input is made.

In addition, in the above-described embodiment, as examples of conducting dictation, sending of a message, calendar registration, and ToDo registration have been illustrated (see FIG. 6). However, other applications are also conceivable without limiting to the above examples. For example, other applications include creation of a document such as a diary, metadata application to a photograph or a moving image, creation of an optional memo, and the like.

It is to be noted that, in the above-described embodiment, an example of making an input by an utterance of a user has been described. However, it is conceivable to give the initiative to a user who has input earlier, also in a case where the inputs are made through touching or gestures. Accordingly, even in the case where the inputs are made through touching or gestures, the initiative can be given to the user who has started the dictation, so that the user to whom the initiative has been given is able to perform a decision operation and the like.

Further, although not described above, it is conceivable that a list of coeditors is provided for each application such as sending of a message and calendar registration. The provision of the list in such a manner enables prevention of, for example, a specific user from relating to editing.

Further, although not described above, an Undo function may be provided in an editing process of a written sentence such as addition and correction in the dictation mode process. This enables the editing process, such as adding, clearing, and correcting, to be performed in an efficient manner.

Further, although not described above, in the dictation mode process, it is conceivable that a specific user, for example, utterances made by a child user are ignored. This enables avoidance of additions in the written sentence caused by unnecessary utterances such as mischief.

Further, in the above-described embodiment, a user who has started dictation has an initiative. However, it is conceivable that such an initiative can be passed on to another user while the dictation is being performed. This enables the another user to whom the initiative has been passed on to end the dictation, even in a case where the user who has started the dictation leaves for some reason while conducting the dictation.

Further, in the above-described embodiment, a user who has started dictation has an initiative. However, instead of deciding the user having the initiative at the time of starting the dictation, the user having the initiative may be decided when necessary.

Further, although not described above, depending on the application, which utterance has been made by which user may be stored. This enables the user who has made an utterance to be identifiable, by coloring the written sentence corresponding to the utterance of each user, or displaying an icon, a symbol, a name, or the like.

Further, although not described above, in a case where a written sentence is cleared, filtering may be performed with a username. For example, “clear the utterances of oo,” or the like. This enables saving of time and effort for designating a sentence to be cleared every time.

Further, in the above-described embodiment, a plurality of users who conducts the dictation includes humans. However, the plurality of users may partially include an AI (artificial intelligence) device.

Further, although not described above, in a case where the written sentence of the utterance in the dictation is cleared, such a cleared part may remain for a certain period of time, for example, in a translucent state, or the like. This enables confirmation of cleared contents and enables a mistakenly cleared content to be returned to the original one.

Further, although not described above, in inputs made by an utterance, a predetermined NG word may be filtered not to be written. In this case, it is conceivable to set the NG word for each user.

Further, although not described above, a written sentence made by an utterance of a user having an initiative may be displayed in an emphasized manner. This enables easy recognition of the written sentence of the utterance of the user having the initiative and enables understanding of who have the initiative.

Further, although not described above, in a case where an utterance of a user having an initiative overlaps with an utterance of another user, a written sentence relating to the utterance of the user having the initiative may be displayed first, and then a written sentence relating to the utterance of another user may be displayed.

Further, although not described above, on a display position of a written sentence relating to an utterance of a user having an initiative, a written sentence relating to an utterance of another user may be merged. This enables easy understanding of which user has the initiative.

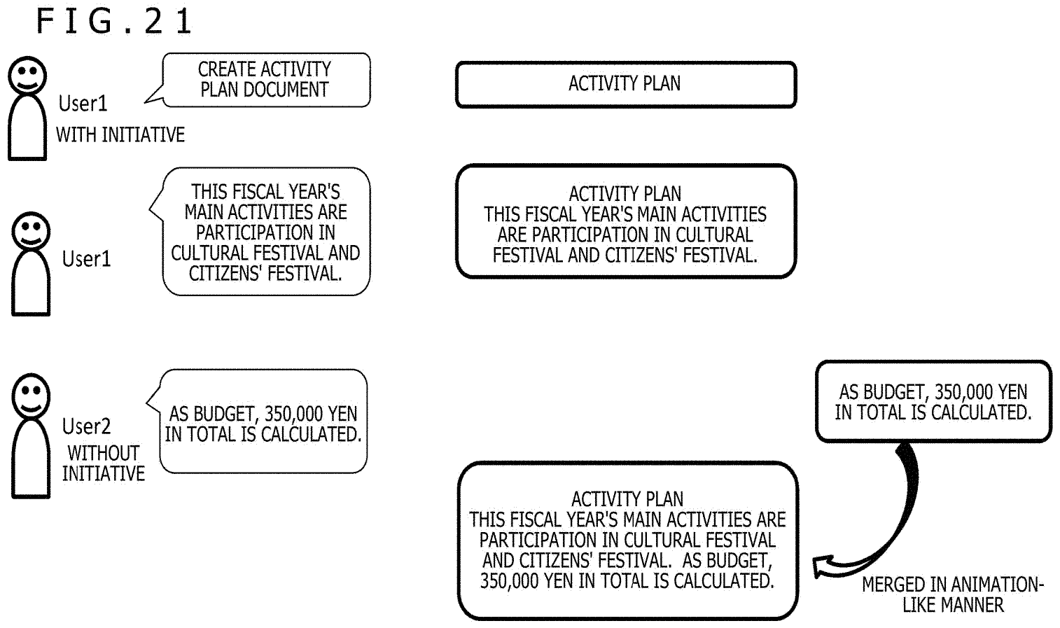

FIG. 21 illustrates an example of a merge operation. First, a dictation mode process for creating an activity plan document is started by an utterance input of a user 1 “create an activity plan document,” and the “activity plan” is displayed as a written sentence. Next, by an utterance input of the user 1 “this fiscal year's main activities are participation in cultural festival and citizens' festival,” a written sentence corresponding to the utterance input is added.

Next, by an utterance input of a user 2 “as budget, 350,000 yen in total is calculated,” a written sentence corresponding to the utterance input is added. In this case, the sentence “as budget, 350,000 yen in total is calculated” is merged on the sentence “activity plan this fiscal year's main activities are participation in cultural festival and citizens' festival,” on the display in an animation-like manner.

In addition, the present technology is capable of having following configurations.
(1)

An information processing apparatus including:

a display control unit configured to control displaying of a written sentence of an utterance in dictation;

a giving unit configured to give an initiative to a predetermined user; and

an edit control unit configured to control such that the user to whom the initiative has been given is able to issue an instruction relating to the written sentence of the utterance.
(2)

The information processing apparatus described in the above (1), in which the display control unit displays the written sentence of the utterance in a state in which a user who has made the utterance is identifiable.
(3)

The information processing apparatus described in the above (1) or (2), in which the display control unit displays the written sentence of the utterance in an undecided state until a decision is made.
(4)

The information processing apparatus described in the above (3), in which the written sentence of the utterance is decided by a timeout or a decision process.
(5)

The information processing apparatus described in one of the above (1) to (4), in which the giving unit gives the initiative to a user who has started the dictation.
(6)

The information processing apparatus described in the above (5), in which the giving unit does not give the initiative in a case where the user who has started the dictation has a predetermined attribute.
(7)

The information processing apparatus described in the above (6), in which the giving unit does not give the initiative in a case where the user who has started the dictation is equal to or younger than a predetermined age.
(8)

The information processing apparatus described in the above (7), in which the giving unit gives the initiative to the user depending on a receiver to whom the written sentence of the utterance is sent, even in the case where the user who has started the dictation is equal to or younger than the predetermined age. (9)

An information processing method including:

a procedure of controlling displaying of a written sentence of an utterance in dictation;

a procedure of giving an initiative to a predetermined user; and

a procedure of controlling such that the user to whom the initiative is given is able to issue an instruction relating to the written sentence of the utterance.

### REFERENCE SIGNS LIST

100 . . . Information processing apparatus

101 . . . Control unit

102 . . . Input and output interface

103 . . . Operation input device

104 . . . Camera

105 . . . Microphone

106 . . . Speaker

107 . . . Display

108 . . . User recognition unit

109 . . . Voice recognition unit

110 . . . Communication interface

111 . . . Semantic analysis guide database

112 . . . Dictation guide database

113 . . . Bus

1. An information processing apparatus comprising:
a display control unit configured to control displaying of a written sentence of an utterance in dictation;
a giving unit configured to give an initiative to a predetermined user; and
an edit control unit configured to control such that the user to whom the initiative has been given is able to issue an instruction relating to the written sentence of the utterance.

2. The information processing apparatus according to claim 1, wherein the display control unit displays the written sentence of the utterance in a state in which a user who has made the utterance is identifiable.

3. The information processing apparatus according to claim 1, wherein the display control unit displays the written sentence of the utterance in an undecided state until a decision is made.

4. The information processing apparatus according to claim 3, wherein the written sentence of the utterance is decided by a timeout or a decision process.

5. The information processing apparatus according to claim 1, wherein the giving unit gives the initiative to a user who has started the dictation.

6. The information processing apparatus according to claim 5, wherein the giving unit does not give the initiative in a case where the user who has started the dictation has a predetermined attribute.

7. The information processing apparatus according to claim 6, wherein the giving unit does not give the initiative in a case where the user who has started the dictation is equal to or younger than a predetermined age.

8. The information processing apparatus according to claim 7, wherein the giving unit gives the initiative to the user depending on a receiver to whom the written sentence of the utterance is sent, even in the case where the user who has started the dictation is equal to or younger than the predetermined age.

9. An information processing method comprising:
a procedure of controlling displaying of a written sentence of an utterance in dictation;
a procedure of giving an initiative to a predetermined user; and
a procedure of controlling such that the user to whom the initiative is given is able to issue an instruction relating to the written sentence of the utterance.
